(19) United States
(12) Patent Application Publication
(10) Pub. No.: US 2006/0149621 A1
(43) Pub. Date: Jul. 6, 2006

(54) Method to provide tactile or audio feedback in a personal shopping device

(76) Inventors: Phuc Ky Do, Morrisville, NC (US); Justin Monroe Pierce, Cary, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/026,217

(22) Filed: Dec. 30, 2004

(51) Int. Cl. G06Q 99/00; G07G 1/14; G06Q 30/00

(52) U.S. Cl. 705/14; 705/1

(57) ABSTRACT

A method, system and computer program product for system for drawing consumer attention to selectively broadcast marketing messages, such as advertisements, store events, and coupons, to a wireless computer mounted on a shopping cart in a store is disclosed. The method comprises positioning a short-range transmitter in a predetermined product area in a store and storing one or more marketing messages in said short-range transmitter, wherein said one or more marketing messages are associated with one or more specific products located in said predetermined product area. The method further comprises using an alert signal to notify a user of an availability of said one or more marketing messages and transmitting said one or more marketing messages to a wireless computer.

### BACKGROUND OF THE INVENTION

1. Technical Field

The present invention relates in general to the field of computers, and in particular to wireless computers receiving signals from short-range transmitting devices. Still more particularly, the present invention relates to a method and system for drawing consumer attention to selectively broadcast marketing messages, such as advertisements, store events, and coupons, to a wireless computer mounted on a shopping cart in a store.

2. Description of the Related Art

A key feature set desired in advertisement is targeting a market and focusing the attention of the market on an advertisement. That is, there is little, if any, short term benefit to the advertiser from sending advertisements to persons who are not likely to purchase the advertiser's product. This is especially true at the actual time of the purchase, such as in a grocery store or similar retail establishment. To target the buying audience in such an environment, the prior art uses two main types of advertising. The first is the broadcasting of an ad playlist throughout the store. Such a playlist may be as simple as an audio message over the store's public address system, or may be via high-tech devices such as wireless Personal Digital Assistants (PDAs). Alternatively, ads can be broadcast to PDAs in only in a limited area by using short-range Bluetooth® technology. An example of such ad placement methods is described in U.S. patent application Ser. No. 09/859,359, entitled “Method and System for Providing Targeted Advertising and Personalized Customer Services,” filed by Hind et al. on May 17, 2001, and herein incorporated by reference in its entirety.

While the prior art provides a certain level of targeted advertising, what is needed is additional ability to focus the attention of the target market, to effectively gauge the effectiveness of the advertisements, and to charge the advertiser accordingly. Further, there is a need to tailor the advertisement to products that the user needs or is likely to need, based on the user's shopping history (both short term as well as long term).

### SUMMARY OF THE INVENTION

A method, system and computer program product for system for drawing consumer attention to selectively broadcast marketing messages, such as advertisements, store events, and coupons, to a wireless computer mounted on a shopping cart in a store is disclosed. The method comprises positioning a short-range transmitter in a predetermined product area in a store and storing one or more marketing messages in said short-range transmitter, wherein said one or more marketing messages are associated with one or more specific products located in said predetermined product area. The method further comprises using an alert signal to notify a user of an availability of said one or more marketing messages and transmitting said one or more marketing messages to a wireless computer.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1 illustrates an exemplary computer system in which the present invention can be implemented, either as a wireless device for receiving a marketing message, a transmitter/receiver for communicating with the wireless device, and/or as a server that exchanges data with the wireless device via the transmitter/receiver;

FIG. 2 depicts an exemplary environment in which the wireless device with tactile or audio feedback is mounted to a shopping cart in a store;

FIG. 3 is an exemplary store plan layout in which the present invention may be implemented;

FIG. 4 illustrates a look-up table that correlates items that have been previously selected by a shopper with other associated products;

FIG. 5 depicts an exemplary Graphical User Interface (GUI) on the wireless device offering one of the associated products to the shopper;

FIG. 6 is a flow chart of steps taken in a preferred embodiment of the present invention to provide tactile and audio feedback to a user and to transmit marketing messages; and

FIG. 7 is a depiction of exemplary uses of a preferred embodiment of the present invention.

### DETAILED DESCRIPTION OF THE PREFERRED EMBODIMENT

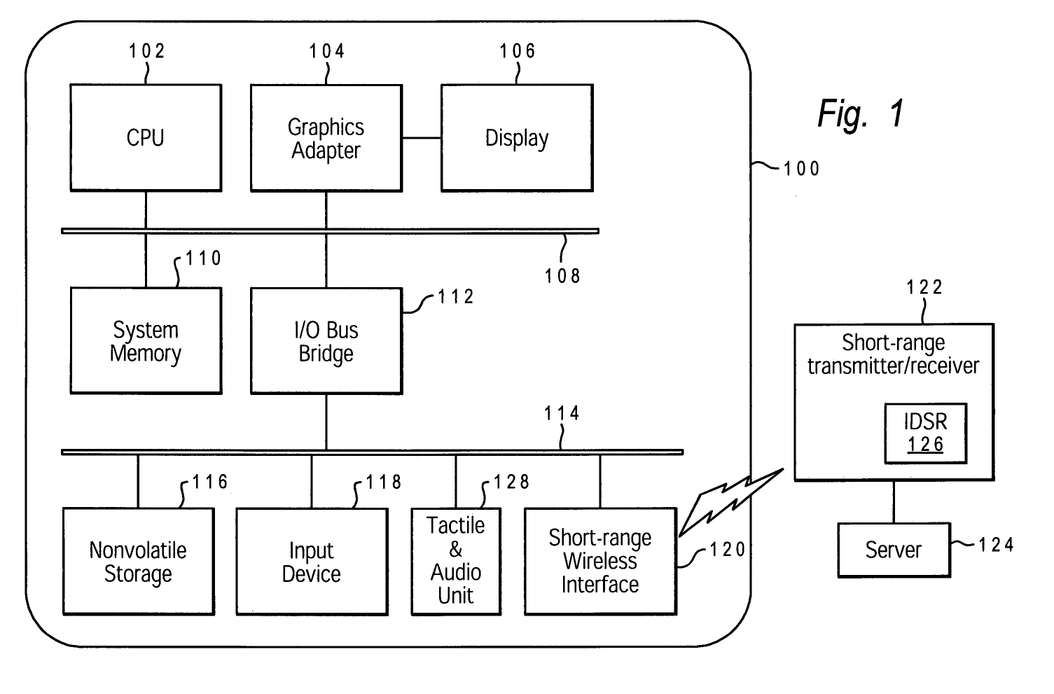

With reference now to FIG. 1, there is depicted a block diagram of an exemplary data processing system in which a preferred embodiment of the present invention may be implemented. Data processing system 100 includes a central processing unit (CPU) 102, which is connected to a system bus 108. In the exemplary embodiment, data processing system 100 includes a graphics adapter 104 also connected to system bus 108, for providing user interface information to a display 106.

Also connected to system bus 108 are a system memory 110 and an input/output (I/O) bus bridge 112. I/O bus bridge 112 couples an I/O bus 114 to system bus 108, relaying and/or transforming data transactions from one bus to the other. Peripheral devices such as nonvolatile storage 116, which may be a hard disk drive, and input device 118, which may include a conventional mouse, a trackball, or the like, as well as a bar code or similar reader, is connected to I/O bus 114. A tactile and audio unit 128, also attaches to I/O bus 114 and provides alert signals to a user via sounds and vibration.

Data processing system 100 also includes a wireless interface 120. Wireless interface 120 is an interface that permits data processing system 100 to wirelessly communicate, preferably via a line-of-sight carrier signal such as a low-power infrared (IR) wave, with another data processing system, such as a short-range transmitter/receiver system 122, which also communicates with a server 124. Note that in a preferred embodiment, all communication is tuned down to a low-power level IR, such that there is only line-of-sight communication, such that no wireless communication occurs from reflected or other “bleed over” signals.

Short-range transmitter/receiver 122 may also include an IDentification Signal Receiver (IDSR) 126. IDSR 126 is a logic (hardware and/or software) that receives and processes an identification signal from a wireless computer such as a Personal Shopping Device (PSD).

In a preferred embodiment, the features shown for data processing system 100 are used by the PSD, while the short-range transmitter/receiver 122 uses all features shown for data processing system 100 except for the graphics adapter 104, tactile and audio unit 128, and display 106, and the server 124 has all features shown for data processing system 100 except for the short-range wireless interface, and tactile and audio unit 128 since server 124 and short-range transmitter/receiver 122 preferably are able to communicate across long distances.

The exemplary embodiment shown in FIG. 1 is provided solely for the purposes of explaining the invention. Those skilled in the art will recognize that numerous variations are possible, both in form and function. For instance, data processing system 100 might also include a compact disk read-only memory (CD-ROM) or digital versatile disk (DVD) drive, a sound card and audio speakers, and numerous other optional components. All such variations are believed to be within the spirit and scope of the present invention.

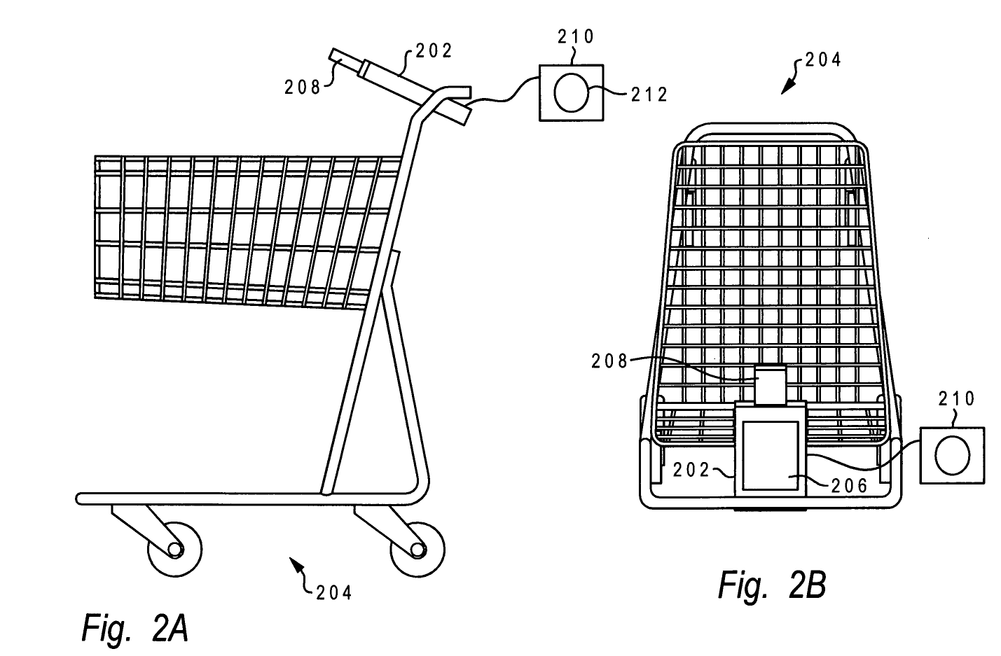

Referring now to FIGS. 2A-B, an exemplary use of data processing system 100 is shown. Data processing system 100 is depicted as a Personal Shopping Device (PSD) 202, which is attached to a shopping cart 204, preferably in a manner that is semi-fixed (i.e., requiring tools to remove PSD 202 from shopping cart 204, in order to prevent the theft of PSD 202). As seen in the top view of FIG. 2b, PSD 202 has an active viewing screen 206, which displays a Graphical User Interface (GUI) for displaying data, as well as for receiving inputs (preferably via a touch-screen capability) into PSD 202. A tactile and audio unit 128 is included a pocket device 210, containing an acknowledge button 212, which is attached to PSD 202 via cable. As one skilled in the art will quickly realize, a tactile and audio unit 128 could, in alternative embodiments, communicate wirelessly with or be integrated within the housing of PSD 202.

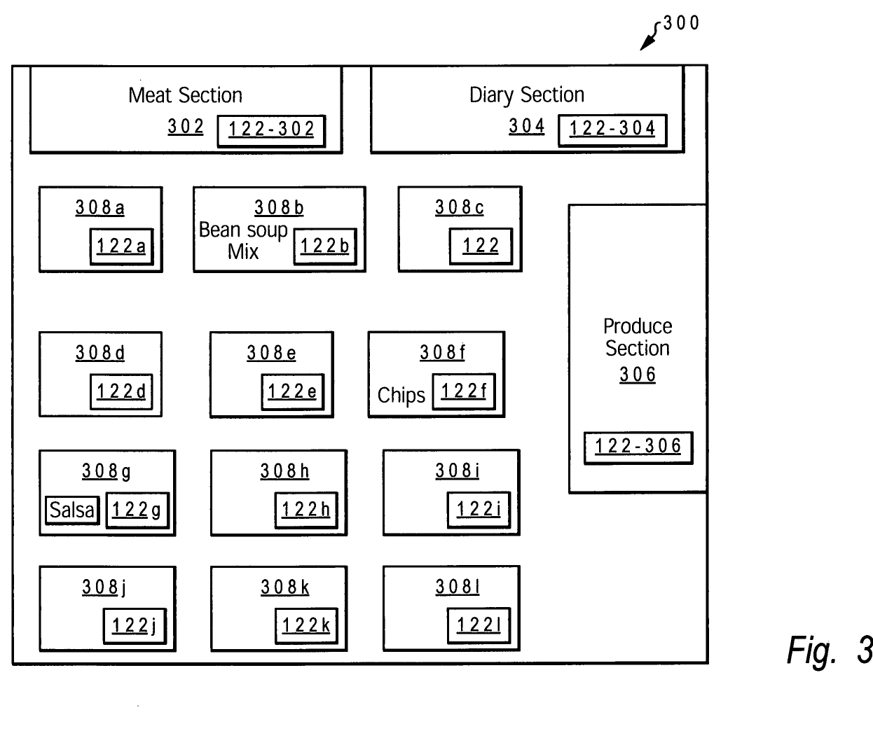

Referring now to FIG. 3, there is illustrated an exemplary environment in which the present invention may be utilized. Store plan 300 depicts an arrangement of a retail store having multiple pre-determined product areas 308. Within each product area 308 is a short-range transmitter/receiver 122. Each short-range transmitter/receiver 122 preferably uses a low-power infrared (IR) carrier signal, such that communication with a short-range transmitter/receiver 122 is only available within the associated pre-determined product area 308 via line-of-sight, and not via reflected or other bleed-over signals. For exemplary purposes, note that store plan 300 may include a meat section 302, a dairy section 304, and a produce section 306, each section also being a pre-determined product area having a short-range transmitter/receiver 122.

An exemplary use of PSD 202 may be in a retail establishment. As a shopper walks a shopping cart 204 equipped with a tactile and audio unit 210, which the user carries in a pocket, the tactile and audio unit can send an alert signal to the user by beeping and vibrating when the user nears an item of interest, such as bean soup mix in product area 308b. The user can then acknowledge the alert signal, by pressing acknowledge button 212. After the user acknowledges the alert signal, the user receives a marketing message over active viewing screen 206. Ideally, the user places items into shopping cart 204 and scans the product using a bar code reader 208, which reads a Universal Product Code (UPC) bar code from a product selected by the shopper and records the product in PSD 202. The PSD 202 stores all items that have been scanned and placed in the shopping cart 204 into a list. When the customer checks out, the checker simply downloads the list (with prices) to conclude a shopping transaction.

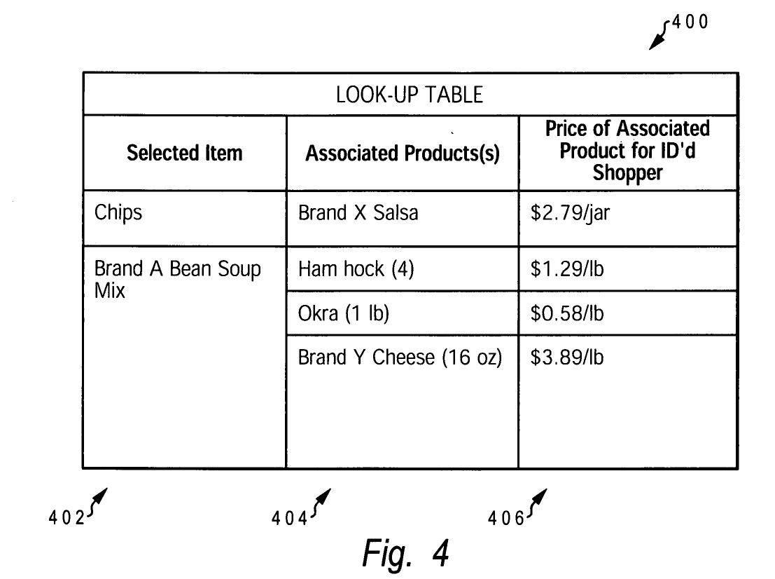

Referring now to FIG. 4, there is depicted a look-up table 400. Look-up table 400 includes a listing of selected products 402, associated products 404, and prices 406. As will be discussed below, there is some type of logical association between the each of the selected products 402 (which a shopper has previously selected and placed in his shopping cart) and each of the associated products 404. The associations in look-up table 400 serve as the basis for marketing messages transmitted to PSD 202. Furthermore, each of the prices 406 that are associated with one of the associated products 404 can be dynamically changed, as discussed in detail below.

In a preferred embodiment, associated products 404 are defined and related to a corresponding selected product 402 by an advertiser. For example, consider the situation in which a shopper has placed a bag of chips (shown as a selected product 402) in his basket while in pre-determined product area 308f. When that same shopper reaches pre-determined product area 308g, a marketing message is sent to that user's PSD 202 suggesting that he pick up the advertiser's “Brand X” salsa listed as one of the associated products 404. That is, preferably the selected product 402 is any brand of that described product, while the associated product 404 is that sold by the advertiser (manufacturer) who is paying for the transmission of the marketing message.

In another preferred embodiment, associated products 404 are defined by a recipe, such as listed on a package. For example, consider the scenario in which the shopper selects a specific bean soup mix, as shown as one of the selected products 402. Printed on the packaging for the bean soup mix, and known to server 124, is a listing of all ingredients that need to be added to the mix, including ingredients that may not be usually kept on hand at the shopper's home. Thus, when the shopper scans and places the bean soup mix in his shopping cart, server 124, upon a local IDSR 126 in a short-range transmitter/receiver 122 subsequently detecting that the shopper who chose the bean soup mix is in a particular pre-determined area, will send marketing messages for the needed ingredients. For example, consider when a shopper selects, scans, and places the particular bean soup mix in his basket when in pre-determined product area 308b. Then, while passing through another pre-determined product area, such as meat section 302, a suggestion (marketing message) message is sent to that user reminding him to pick up ham hocks for his soup. Optionally, a special price for that shopper alone, may be offered. Thus, the prices 406 can be dynamically modified. Similarly, suggestions are made to the shopper when in dairy section 304 to pick up needed Brand Y cheese and to pick up okra when in the produce section 306.

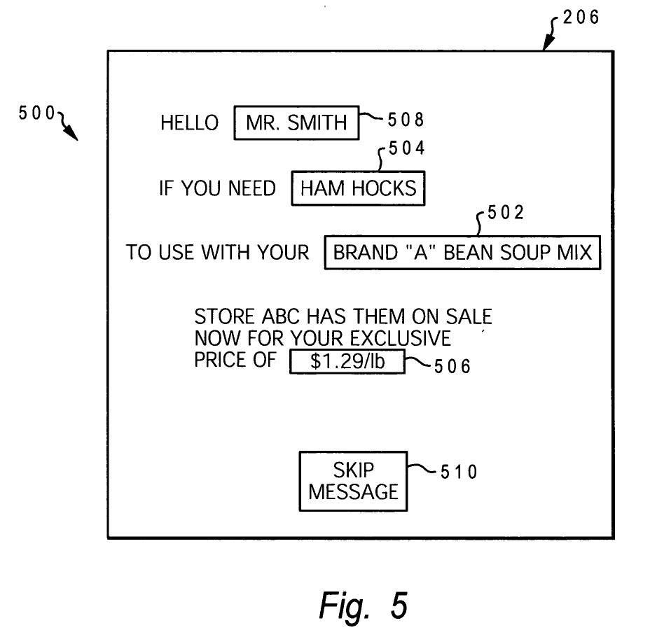

Referring now to FIG. 5, a GUI 500, displayed on active viewing screen 206 of PSD 202, is shown as it would appear when the shopper who selected the bean soup mix passes through the meat section 302. The GUI 500 includes dynamically populated active region 502, which is populated from a selected product 402 in look-up table 400. Similarly, active region 504 is populated from associated products 404, while active field 506 is populated from prices 406. Active field 508 is populated by the ISDR 126 in a local short-range transmitter/receiver 122, which, using the shopper's ID, sends the shopper's actual name to active field 508. If the shopper wishes to skip the marketing message at any time, then he clicks (touches the active screen) the skip button 510. If and when the skip button 510 is clicked, the local short-range transmitter/receiver 122 and the server 124 record this event, and how long the marketing message was displayed in the GUI 500. Alternatively, messages can be tied to store events, such as a user's deli order having been completed, and marketing messages can include additional information about merchandise.

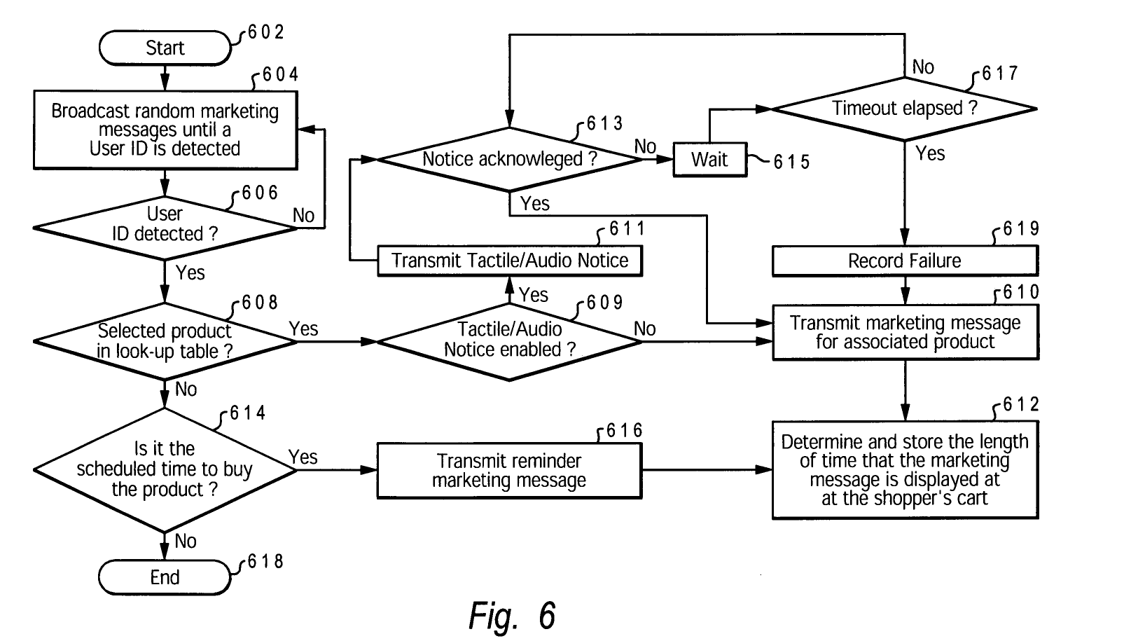

With reference now to FIG. 6, a flow chart of preferred steps taken to provide tactile and audio feedback and transmit marketing messages is shown. After initiator block 602, a random marketing message is broadcast (block 604) within a short-range predetermined area, such as by one of the short-range transmitters/receivers 122 shown in FIG. 3. These random marketing messages are broadcast to any PSD 202 until an identifier (ID) from a PSD 202 is detected by the IDSR 126 in the vicinity of short-range transmitter/detector 122 (query block 606). Preferably, these marketing messages are stored in either the server 124, or alternatively the short-range transmitter/receiver 122, which broadcasts the marketing message in real time to the PSD 202, preferably via a low-power infrared (IR) carrier signal that is only line-of-sight enabled (not capable of being read after reflection, deflection, etc.), thus ensuring that the IR signal is only read within the short-range predetermined area.

Next, a query is made (query block 608) as to whether a product or other item of interest, which has been selected user nears an item of interest, such as bean soup mix in product area 308b, matches one of the selected products 402 in look-up table 400. If the selected product 402 is not provided in look-up table 400, then a query is also made (query block 614) as to whether it is the scheduled time for the user identified to purchase an item located with the pre-determined product area in which the short-range transmitter/receiver 122 is located.

A shopping history, stored in short-range transmitter/receiver 122 and/or server 124, for the shopper identified by the ID from the PSD 202, is accessed. This shopping history includes a periodic schedule of when specific items should be purchased by the shopper. For example, the shopping history may know that the shopper needs to buy a new air conditioner filter every 60 days. If 60 days have elapsed since the shopper purchased her last air conditioner filter, then a reminder message is sent to the PSD 202 (block 616), preferably suggesting that the shopper purchase a particular brand and/or model of air conditioner filter. The length of time that this reminder message is likewise stored (block 612), and the process ends (terminator block 618).

Returning to block 608, if the selected product, matches one of the selected products 402 in look-up table 400, then the process next moves to block 609, which depicts server 124 determining whether tactile or audio notice is enabled for providing alert signals through PSD 202 with tactile and audio unit 210. If tactile or audio notice is enabled for PSD 202 through tactile and audio unit 210, then the process next moves to block 611, which depicts PSD 202 transmitting tactile or audio notice through tactile and audio unit 210. The process then moves to block 613.

At block 613, PSD 202 determines whether tactile or audio notice from tactile and audio unit 210 has been acknowledged by a user by pressing acknowledge button 202. If the marketing message has not been acknowledged, then the process proceeds to block 615, in which PSD 202 waits for the user to acknowledge the tactile or audio feedback. The process then moves to block 617, which depicts PSD 202 determining whether a timeout has elapsed. If a timeout has not elapsed, then the process returns to block 613, which is described above. If a timeout has elapsed, then the process next moves to block 619, where a timeout failure is recorded. Following block 619, or alternatively following determination in block 609 that alert signals using tactile and audio notice are not enabled, or alternatively following a determination in step 613 that an alert signal through tactile and audio notice has been acknowledged, the process then moves to block 610.

At block 610 a marketing message related to one of the associated products 404 is broadcast to the PSD 202 (block 610). The length of time that the marketing message was displayed on the GUI in the PSD 202 is determined and stored by the short-range transmitter/receiver 122 and/or the server 124 (block 612).

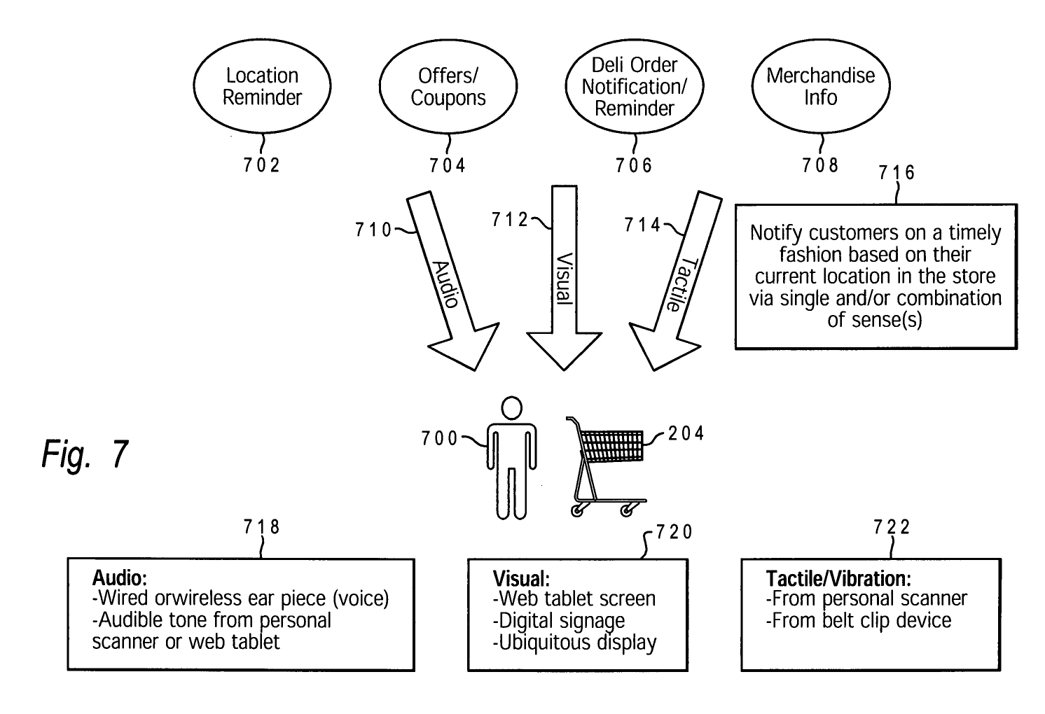

Turning now to FIG. 7, a depiction of exemplary uses of the preferred embodiment of the present invention is illustrated. As described with respect to the preferred embodiment of the present invention, marketing messages can consist of multiple message types including the following: a location reminder 702, offers or coupons 704, notification that a deli order has been completed or reminder to pick-up a deli order 706, or merchandise information 708. Other types of marketing messages, not depicted in the examples of the preferred embodiment illustrated herein, will also occur to those skilled in the art and will fall within the scope and spirit of the present invention.

As illustrated, the preferred embodiment can provide multiple forms of alert signal, including audio notices 710, visual notices through active viewing screen 206, and tactile notices. Audio notices 710 and tactile notices 714 are provided through audio and tactile notification unit 210. Audio notices 710, visual notices 712 and tactile notices 714 are used to notify customers in a timely fashion based on current location of the store via single and/or combination of the senses, as depicted at block 716. These notices allow a user, while pushing a shopping cart 204, to respond to audio stimuli 718, which include alert signals from audio and tactile feedback unit 210, which could take the form of a wired or wireless earpiece. If audible and tactile notification unit 210 is integrated into personal shopping device 202, then an audible tone from within personal shopping device 210, which may take the form of a personal scanner or web tablet may also be used.

Visual stimulation 720 may come from a web tablet screen on personal shopping device 210 or, alternatively, from digital signage of other displays. Tactile and vibration notification alert signals may come from tactile and audible feedback unit 210, which may take the form of a belt clip device. Alternatively, audible and tactile notification unit 210 may be integrally built into a personal scanner such as personal shopping device 202.

The present invention provides the ability to notify a customer of the availability of an item through tactile and audio feedback. Use of tactile and audio feedback allows a tremendous improvement in the shopping experience, because the user is able concentrate on driving a cart or looking at items, rather than being constantly distracted by messages on a view screen. Use of the present invention improves enjoyment of the shopping experience and safety of users.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method comprising:
positioning a short-range transmitter in a predetermined product area in a store;
storing one or more marketing messages in said short-range transmitter, wherein said one or more marketing messages are associated with one or more specific products located in said predetermined product area;
using an alert signal to notify a user of an availability of said one or more marketing messages; and
transmitting said one or more marketing messages to a wireless computer.

2. The method of claim 1, wherein said step of using said alert signal to notify said user of said availability of said one or more marketing message further comprises using a vibrator unit to notify said user of said availability of said one or more marketing messages.

3. The method of claim 1, wherein said step of using said alert signal to notify said user of said availability of said one or more marketing message further comprises using an audio unit to notify said user of said availability of said one or more marketing messages.

4. The method of claim 1, wherein said step of transmitting said one or more marketing messages to said wireless computer further comprises transmitting said one or more marketing messages to said wireless computer in response to an acknowledgment of said alert signal.

5. The method of claim 1, wherein said step of transmitting said one or more marketing messages to said wireless computer further comprises transmitting said one or more marketing messages to said wireless computer in response to a failure acknowledge said alert signal.

6. The method of claim 1, wherein said step of transmitting said one or more marketing messages to said wireless computer in response to said failure acknowledge said alert signal further comprises recording said failure to acknowledge said alert signal.

7. The method of claim 1, wherein said step of transmitting said one or more marketing messages to said wireless computer further comprises transmitting said one or more marketing messages, wherein said one or more marketing messages notify said user that a product of interest is in proximity to said wireless unit.

8. A system comprising:
a short-range transmitter in a predetermined product area in a store;
a memory for storing one or more marketing messages in said short-range transmitter, wherein said one or more marketing messages are associated with one or more specific products located in said predetermined product area;
an alert signal unit for using an alert signal to notify a user of an availability of said one or more marketing messages; and
a transmitter for transmitting said one or more marketing messages to a wireless computer.

9. The system of claim 8, wherein said alert signal unit for using said alert signal to notify said user of said availability of said one or more marketing message further comprises a vibrator unit for notifying said user of said availability of said one or more marketing messages.

10. The system of claim 8, wherein said alert signal unit for using said alert signal to notify said user of said availability of said one or more marketing message further comprises using an audio unit to notify said user of said availability of said one or more marketing messages.

11. The system of claim 8, wherein said transmitter for transmitting said one or more marketing messages to said wireless computer further comprises means for transmitting said one or more marketing messages to said wireless computer in response to an acknowledgment of said alert signal.

12. The system of claim 8, wherein said transmitter for transmitting said one or more marketing messages to said wireless computer further comprises means for transmitting said one or more marketing messages to said wireless computer in response to a failure acknowledge said alert signal.

13. The system of claim 12, wherein said transmitter for transmitting said one or more marketing messages to said wireless computer in response to said failure acknowledge said alert signal further comprises means for recording said failure to acknowledge said alert signal.

14. The system of claim 8, wherein said transmitter for transmitting said one or more marketing messages to said wireless computer further comprises means for transmitting said one or more marketing messages, wherein said one or more marketing messages notify said user that a product of interest is in proximity to said wireless unit.

15. A computer program product in a computer-readable medium comprising:
a computer-readable medium;
instructions on the computer-readable medium for positioning a short-range transmitter in a predetermined product area in a store;
instructions on the computer-readable medium for storing one or more marketing messages in said short-range transmitter, wherein said one or more marketing messages are associated with one or more specific products located in said predetermined product area;
instructions on the computer-readable medium for using an alert signal to notify a user of an availability of said one or more marketing messages; and
instructions on the computer-readable medium for transmitting said one or more marketing messages to a wireless computer.

16. The computer program product of claim 15, wherein said instructions for using said alert signal to notify said user of said availability of said one or more marketing message further comprises instructions on the computer-readable medium for using a vibrator unit to notify said user of said availability of said one or more marketing messages.

17. The computer program product of claim 15, wherein said instructions for using said alert signal to notify said user of said availability of said one or more marketing message further comprises instructions on the computer-readable medium for using an audio unit to notify said user of said availability of said one or more marketing messages.

18. The computer program product of claim 15, wherein said instructions for transmitting said one or more marketing messages to said wireless computer further comprises instructions on the computer-readable medium for transmitting said one or more marketing messages to said wireless computer in response to an acknowledgment of said alert signal.

19. The computer program product of claim 15, wherein said instructions for transmitting said one or more marketing messages to said wireless computer further comprises instructions on the computer-readable medium for transmitting said one or more marketing messages to said wireless computer in response to a failure acknowledge said alert signal.

20. The computer program product of claim 19, wherein said instructions for transmitting said one or more marketing messages to said wireless computer in response to said failure acknowledge said alert signal further comprises instructions on the computer-readable medium for recording said failure to acknowledge said alert signal.

21. The computer program product of claim 19, wherein said instructions for transmitting said one or more marketing messages to said wireless further comprises instructions on the computer-readable medium for transmitting said one or more marketing messages, wherein said one or more marketing messages notify said user that a product of interest is in proximity to said wireless unit.

22. The computer program product of claim 19, wherein said instructions for transmitting said one or more marketing messages to said wireless further comprises instructions on the computer-readable medium for transmitting said one or more marketing messages, wherein said one or more marketing messages notify said user that of a relevant store event.
